(19) United States
(12) Patent Application Publication
(10) Pub. No.: US 2007/0119866 A1
(43) Pub. Date: May 31, 2007

(54) Drink delivery apparatus and method for race car drivers

(76) Inventor: Jeffry T. Sheppard, Golden Valley, AZ (US)

Correspondence Address: WEISS & MOY PC, 4204 NORTH BROWN AVENUE, SCOTTSDALE, AZ, 85251, US

(21) Appl. No.: 11/274,826

(22) Filed: Nov. 15, 2005

(51) Int. Cl. B67D 5/64

(52) U.S. Cl. 222/175

(57) ABSTRACT

An improved drink delivery apparatus and method permits a race car driver to obtain a drinkable liquid from a reservoir without having to remove a hand from the steering wheel. A hose transports a drinkable liquid from the reservoir, to a hose end that is located within a race car helmet and proximate a racer's mouth. In one embodiment, an electrically powered pump is utilized to propel the drinkable liquid through the hose, which pump is activated by a switch located on the race car steering wheel.

### FIELD OF THE INVENTION

The present invention relates generally to drink delivery apparatuses and methods and, more particularly, to a drink delivery apparatus and method that permits a race car driver to obtain a drink of fluid without removing his hands from the steering wheel.

### BACKGROUND OF THE INVENTION

Race car driving is a physically demanding sport for the participants. Like other endurance athletes, a driver in an event of any significant length, such as a NASCAR race, must consume fluids in order to continue to function at a high level, Typically, drivers accomplish this by grasping a water bottle with one hand and bringing the bottle up to the mouth.

However, there are various drawbacks with this method. A driver may need to avert his eyes momentarily from the track in order to locate the bottle, with potentially dangerous consequences, In addition, the removal of one hand from the steering wheel of a high performance race car in the middle of a race can also be risky,

A need therefore exists for an apparatus and method that permits a race car driver to obtain a drink of fluids, during a race, without the need to remove either hand from the steering wheel. The present invention satisfies this need, and provides other related advantages.

### SUMMARY OF THE INVENTION

In accordance with an embodiment of the present invention, an improved drink delivery apparatus is disclosed. The apparatus comprises, in combination: a reservoir containing a drinkable liquid; a hose having a first end and a second end; wherein the first end of the hose is positioned so as to carry the drinkable liquid out of the reservoir; an auto racing helmet having the second end of the hose inserted therethrough and positioned within an interior of the auto racing helmet; and means for delivering the drinkable liquid from the first end of the hose to the second end of the hose.

In accordance with another embodiment of the present invention, a method for delivering drinkable liquid to a race car driver is disclosed. The method comprises providing a reservoir containing a drinkable liquid; providing a hose having a first end and a second end; wherein the first end of the hose is positioned so as to carry the drinkable liquid out of the reservoir; providing an auto racing helmet having the second end of the hose inserted therethrough and positioned within an interior of the auto racing helmet; providing means for delivering the drinkable liquid from the first end of the hose to the second end of the hose; utilizing the delivering means for delivering the drinkable liquid from the first end of the hose to the second end of the house.

### BRIEF DESCRIPTION OF THE DRAWINGS

FIG. 1 is a perspective view of a helmet, illustrating coupling of a drinking hose thereto.

FIG. 2 is a perspective view of the helmet of FIG. 1, illustrating that the drinking hose extends into the interior of the helmet, so as to be proximate a driver's mouth.

FIG. 3 is a front view of a race car steering wheel, illustrating coupling between the wheel and an activation cord from a drink pump.

FIG. 4 is a side, cross-sectional view of a drink reservoir, having a drink pump therein.

### DETAILED DESCRIPTION OF THE PREFERRED EMBODIMENTS

Referring first to FIG. 4, a drink reservoir 10 is shown. In one embodiment, the drink reservoir 10 has a pump 12 located therein. The pump 12 is adapted to pump liquid 14 out of the reservoir 10 via hose 16. The liquid 14 may be water, a performance beverage, or any desired drink that may be consumed by a race driver. The reservoir 10 may be filled following removal of fill cap 17, which covers a fill opening.

The pump 12 may be coupled to the race car's electrical system or powered by a separate battery (not shown) utilizing wiring 18. In one embodiment, the pump 12 is switch operated. In this embodiment, a button-type switch 20 is positioned on a steering wheel 22. Preferably, the switch 20 is positioned so that it may be activated by a driver's thumb or other finger, without the driver having to remove a hand from the steering wheel 22. The switch 20 may be in electrical communication with the pump 12 via wiring 18.

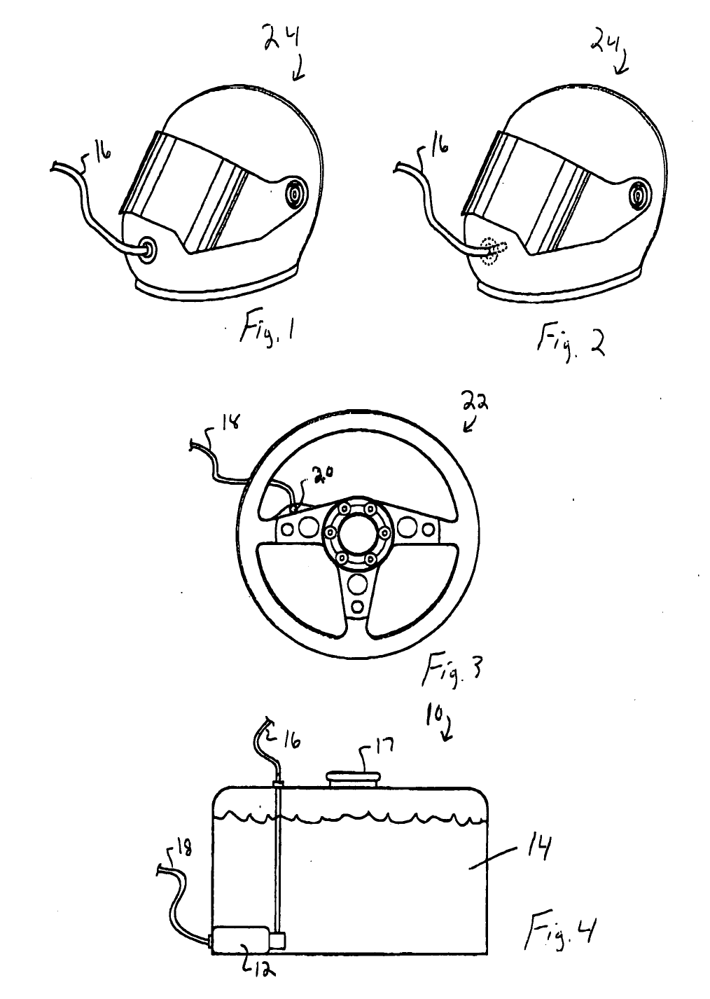

Referring now to FIGS. 1-2, the hose 16 may be coupled to a helmet 24, proximate a mouth of a driver. As seen more specifically in FIG. 2, the hose 16 extends into the interior of the helmet 24. Preferably, a terminus of the hose 16 in the interior of the helmet 24 is in sufficient proximity to the driver's mouth so that the driver can readily, in a hands-free manner, bite down on or otherwise grasp the hose end in the mouth for purposes of receiving liquid 14.

In this embodiment, a driver may obtain a drink of liquid 14 by depressing switch 20. That causes activation of the pump 12, which pumps liquid 14 through hose 16 into the interior of the helmet 24. By taking the end of the hose 16 into the mouth, the driver may then receive liquid 14. In performing these steps, the driver is never required to remove a hand from the steering wheel 22.

It may be desired to provide a bite valve (not shown) on the end of the hose 16 inside the helmet 24, so as to prevent accidental discharge of liquid 14 outside of the mouth of the driver. In this fashion, a driver can, after activating the pump 12 and upon being ready to drink, bite down on the bite valve, and thereby permit the flow of liquid 14 to begin.

It should be noted that the pump 12 represents only one possible means for propelling liquid 14 in a direction of a mouth of a driver, via hose 16. For example, it may be desired to place the liquid 14 within the reservoir 10 under pressure, so that an opening of a valve, such as a bite valve, on an end of hose 16 will result in a flow of liquid without the need for a pumping apparatus.

In addition, it should be noted that even where a pumping 12 is utilized, the switch 20 may be placed within a different place within the car, without departing from the spirit or scope of the present invention, which is intended to permit the delivery of liquid 14 to a driver without requiring the removal of a hand from the steering wheel 22. For example, a the switch 20 may be incorporated into a bite valve or the like positioned on an end of the hose 16, so that a driver's biting down thereon both opens the hose end and activates the pump.

While the invention has been particularly shown and described with reference to preferred embodiments thereof, it will be understood by those skilled in the art that the foregoing and other changes in form and details may be made therein without departing from the spirit and scope of the invention.

I claim:

1. An improved drink delivery apparatus comprising, in combination:
a reservoir containing a drinkable liquid;
a hose having a first end and a second end;
wherein the first end of the hose is positioned so as to carry the drinkable liquid out of the reservoir;
an auto racing helmet having the second end of the hose inserted therethrough and positioned within an interior of the auto racing helmet; and
means for delivering the drinkable liquid from the first end of the hose to the second end of the hose.

2. The apparatus of claim 1 wherein the delivering means is a pump.

3. The apparatus of claim 2 further comprising a pump activating switch, wherein the pump activating switch is located on a steering wheel of a race car.

4. A method for delivering drinkable liquid to a race car driver comprising:
providing a reservoir containing a drinkable liquid;
providing a hose having a first end and a second end;
wherein the first end of the hose is positioned so as to carry the drinkable liquid out of the reservoir;
providing an auto racing helmet having the second end of the hose inserted therethrough and positioned within an interior of the auto racing helmet;
providing means for delivering the drinkable liquid from the first end of the hose to the second end of the hose;
utilizing the delivering means for delivering the drinkable liquid from the first end of the hose to the second end of the house.

5. The method of claim 4 wherein the delivering means is a pump.

6. The method of claim 5 further comprising a pump activating switch, wherein the pump activating switch is located on a steering wheel of a race car, and wherein the step of utilizing the delivering means comprises operating the pump activating switch while maintaining portions of two hands on the steering wheel.
